(19) United States
(12) Patent Application Publication
(10) Pub. No.: US 2023/0129275 A1
(43) Pub. Date: Apr. 27, 2023

(54) FLOWERPOT INCLUDING WATER SUPPLY TUBE

(71) Applicant: GREENWALL CO., LTD., Busan (KR)

(72) Inventor: Youngwoo SONG, Busan (KR)

(21) Appl. No.: 17/915,730

(22) PCT Filed: Apr. 2, 2021
(86) PCT No.: PCT/KR2021/004153

§ 371 Date: Sep. 29, 2022

(30) Foreign Application Priority Data
Apr. 2, 2020 (KR) 10-2020-0040393

(51) Int. Cl. A01G 27/00

(52) U.S. Cl. CPC A01G 27/005

(57) ABSTRACT

Proposed is a flowerpot including a water supply tube. The flowerpot is configured such that in a state where multiple flowerpots are arranged, adjacent flowerpots are connected to each other by using the water supply tube made of a silicone rubber material having a flexible elastic property to enable water supply, so as to provide a flexible layout between the flowerpots while preventing leakage of water.

### TECHNICAL FIELD

The present disclosure relates to a flowerpot including a water supply tube. In a state in which a plurality of flowerpots are placed, the present disclosure provides a flexible arrangement state between the flowerpots by connecting adjacent pots with a water supply tube made of silicone rubber material having a flexible elastic property to supply water while preventing leakage of water.

### BACKGROUND ART

A flowerpot needs to be continuously supplied with an adequate amount of water so that plants can survive and grow.

As an embodiment, a method of directly periodically watering the flowerpot is used, and as another embodiment, a method of storing a flowerpot with a water absorption hole formed at the bottom in a water tray and supplying water to the water tray to allow the plants in the flowerpot to absorb water is also used.

On the other hand, recently, in case of a flowerpot installed for wall decoration (wall planting), the flowerpot has a structure in which a small flowerpot casing is stored in a water tray casing, and a plurality of flowerpots with such structure are stacked in a vertical direction or arranged in a plurality of rows in a horizontal direction.

As an embodiment of the conventional art, Korean Patent No. 10-1296738 (registered on Aug. 8, 2013) relates to the wall planting flowerpots and a wall planting vertical garden system using the same, and proposes a configuration in which a frame is installed by assembling the plurality of wall planting flowerpots in a state of stacked in the vertical direction or arranged in the horizontal direction.

However, in the conventional art, water is sprayed from a water supply tube installed on the top of an uppermost flowerpot, and this water stays in the soil in an upper flowerpot and then flows to a lower flowerpot through the bottom drain or out of the flowerpot through the side drain. Therefore, the configuration of supplying water by connecting the plurality of flowerpots arranged in the horizontal direction to each other was not considered. Moreover, for this reason, in the conventional art, there was cumbersome work of distributing water as much as the number of flowerpots arranged in the horizontal direction when supplying water to the upper part.

As another embodiment of the conventional art, Japanese Patent Laid-Open No. 2003-325052 (registered on Nov. 18, 2003) relates to a planting pot, wherein a configuration in which a plurality of planting pots can be simply installed on the wall of the building, and a water preservation and supply system is proposed.

However, although the above technology proposed the structure for water supply between planting pots arranged in the horizontal direction, this structure cannot be applied in a state in which a wall surface of the planting pots are not in contact to each other, since the structure forms a water supply tube by inserting a screw pipe-shaped hollow member between multiple planting pots in an adjacent position wherein the walls of the planting pots contact each other. There was also a limitation in that it is not easy to insert the screw pipe-shaped hollow member if the contact state of the walls of the adjacent planting pots is not accurate. In particular, when the plurality of planting flowerpots are to be installed adjacently, the above-described limitation becomes a bigger problem.

Meanwhile, interest in wall greening (vertical garden) is increasing recently. Due to the characteristics of wall greening, dozens or hundreds of small-sized flowerpots for wall planting have to be stacked and interlocked to supply water. Since there is no suitable water supply tube connector, large and rugged industrial connectors are used at some plant installations. Such connectors occupy a large installation space, are not aesthetically pleasing, and have limitations in use that flexible installation is difficult due to the property of a rigid material.

### DISCLOSURE

### Technical Problem

Accordingly, the present disclosure has been made in an effort to solve the problems described above and an objective of the present disclosure is to provide a flowerpot including a water supply tube configured to prevent water leakage while providing a flexible arrangement between flowerpots by connecting adjacent flowerpots with a water supply tube made of silicone rubber material having a flexible elastic property when a plurality of flowerpots are placed.

### Technical Solution

In order to achieve the above-described objectives, there is provided a flowerpot including the water supply tube that includes: a flowerpot body capable of storing water thereof, being open at an upper end, and having at least one through-hole at one side thereof, and a water supply tube configured as a hollow silicone rubber hose having an outer diameter larger than an inner diameter of the through-hole, and configured to be inserted into the through-hole in a state in which the outer diameter thereof is elastically reduced by an external force and is configured to achieve a close contact state with an inner surface of the through-hole when the outer diameter of the water supply tube is elastically restored by removing the external force while being inserted into the through-hole wherein a plurality of the flowerpots are arranged to be adjacent to each other and interconnected with the water supply tube.

Preferably, the present disclosure further includes a connecting tube made of a harder material than the silicone rubber hose and configured to be inserted into a hollow part of the water supply tube when being inserted into the through-hole of the flowerpot body.

Preferably, an outer diameter of the connecting tube is configured to be smaller than the inner diameter of the through-hole, and at least a portion of the connecting tube is inserted into the hollow part of the water supply tube to achieve a close contact state while being inserted into the through-hole of the flowerpot body.

Preferably, the outer diameter of the connecting tube is configured to be not smaller than the inner diameter of the through-hole, and the connecting tube is inserted into the hollow part of the water supply tube to achieve the close contact state while not inserted into the through-hole of the flowerpot body.

Preferably, the connecting tube is configured in a form in which a first section thereof having an outer diameter smaller than the inner diameter of the through-hole and a second section thereof having an outer diameter not smaller than the inner diameter of the through-hole are integrally connected to each other along a longitudinal direction, wherein in the first section, a part of the connecting tube is inserted into the hollow part of the water supply tube to form close contact state while being inserted into the through-hole of the flowerpot body, and in the second section, the connecting tube is inserted into the hollow part of the water supply tube to form the close contact state while not inserted to the through-hole of the flowerpot body.

Preferably, one flowerpot and another flowerpot are adjacently arranged side by side, and one water supply tube is inserted into the through-hole of each flowerpot, and the outer diameter of the connecting tube is smaller than the inner diameter of the through-hole, and the connecting tube is configured such that in a state in which one connecting tube is inserted into the hollow part of the water supply tube, the connecting tube passes through the through-hole of one flowerpot body and passes through the through-hole of the other flowerpot body to achieve the close contact state.

Preferably, the connecting tube is made of a urethane material or a metal material.

Preferably, the connecting tube has an outer diameter larger than the inner diameter of the water supply tube.

Preferably, the water supply tube is configured to prevent the leakage of water by being brought into close contact with the inner surface of the through-hole due to an elastic restoring force of the silicone rubber hose.

Preferably, the flowerpot body is formed of a harder material than the silicone rubber hose.

### Advantageous Effects

According to the present disclosure, in a state in which a plurality of flowerpots are arranged, an advantage of preventing water leakage and an advantage of a flexible position or distance relationship between the flowerpots are provided by connecting adjacent flowerpots using a water supply tube made of silicone rubber material having flexible elastic property.

In addition, since the present disclosure uses the water supply tube made of silicone rubber material, the water supply tube can be installed by simple insertion using elastic compression and restoration of the water supply tube, and there is an advantage in that a complicated process such as screw assembly is unnecessary.

Furthermore, the present disclosure has the advantage of making a connection between the water supply tube and the flowerpot body more robust by using a connecting tube formed of harder material than the water supply tube made of silicone rubber.

### DESCRIPTION OF DRAWINGS

FIG. 1 is an exploded perspective view illustrating a flowerpot including a water supply tube according to an embodiment of the present disclosure,

FIG. 2 is an exploded perspective view illustrating a connection structure of the flowerpot including the water supply tube according to an embodiment of the present disclosure,

FIG. 3 is a partially extracted cross-sectional view illustrating the connection structure of the flowerpot including the water supply tube according to an embodiment of the present disclosure,

FIG. 4 is a partially extracted cross-sectional view illustrating the connection structure of the flowerpot including the water supply tube according to another embodiment of the present disclosure,

FIG. 5 is a partially extracted cross-sectional view illustrating the connection structure of the flowerpot including the water supply tube according to a further embodiment of the present disclosure,

FIG. 6 is a partially extracted cross-sectional view illustrating the connection structure of the flowerpot including the water supply tube according to a yet further embodiment of the present disclosure,

FIG. 7 is a partially extracted cross-sectional view illustrating the connection structure of the flowerpot including the water supply tube according to a still yet further embodiment of the present disclosure.

### BEST MODE

The present disclosure may be implemented in various forms without departing from its technical concept or major features. Therefore, embodiments of the present disclosure are merely examples in all respects and should not be interpreted limitedly.

The terms first and/or second, etc. are used to distinguish one component from another component. For example, a first component may be referred to as a second component, and the second component may be also referred to as the first component without departing from the scope of the present disclosure.

It will be understood that when any element is referred to as being “connected” or “coupled” to another element, one element may be directly connected or coupled to the other element, or an intervening element may be present therebetween.

The singular forms used herein are intended to include the plural forms as well unless the context clearly indicates otherwise. In the present disclosure, the terms such as “include” or “have” are intended to specify that components, or a combination thereof exist, and it should be understood that the presence or addition of one or more other components, or combinations thereof are not excluded in advance.

Herein below, preferred embodiments of the present disclosure will be described in detail with reference to the accompanying drawings.

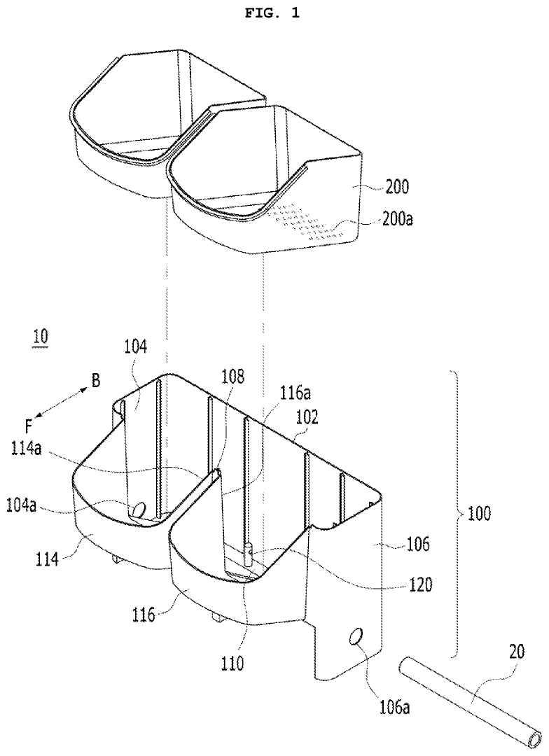

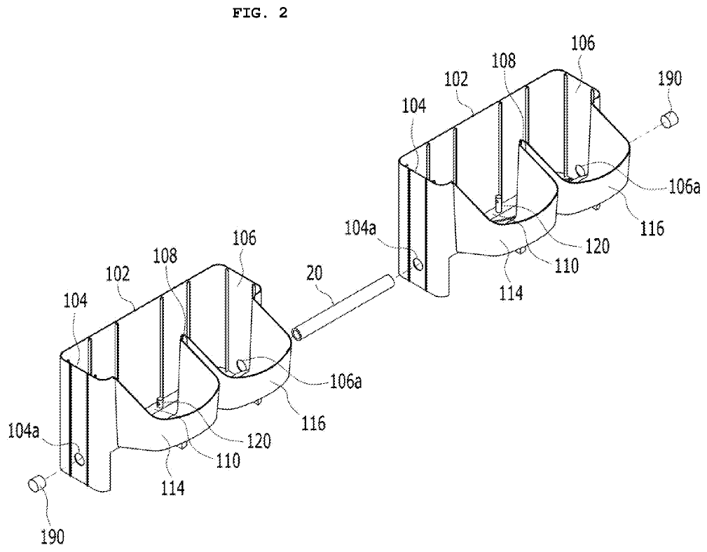

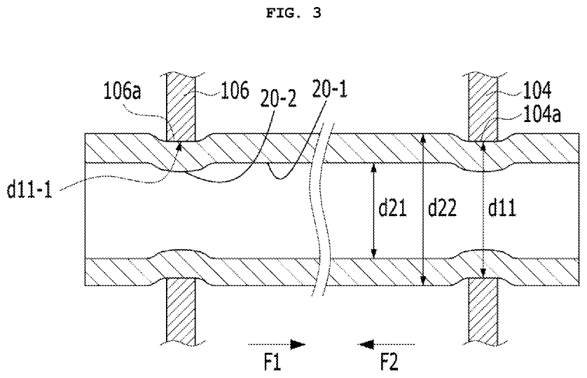

FIG. 1 is an exploded perspective view illustrating a flowerpot including a water supply tube according to an embodiment of the present disclosure, FIG. 2 is an exploded perspective view illustrating a connection structure of the flowerpot including the water supply tube according to an embodiment of the present disclosure, and FIG. 3 is a partially extracted cross-sectional view illustrating the connection structure of the flowerpot including the water supply tube according to an embodiment of the present disclosure.

The flowerpot of the embodiment is a flowerpot 10 that can be used by stacking a plurality of adjacent flowerpots 10 in the vertical direction or arranging them in the horizontal direction and interconnecting them through a water supply tube 20. FIGS. 1 and 2 illustrate a shape of the flowerpot based on a known wall greening flowerpot.

The flowerpot of the embodiment may include a flowerpot body 100 and a flowerpot casing part 200 as illustrated in FIGS. 1 and 2, however, if the plurality of flowerpots 10 are stacked and combined in the vertical direction or arranged in the horizontal direction, the embodiment is not limited to the illustrated structure. For example, only the flowerpot body 100 may be used without the flowerpot casing part 200, and the shape of the flowerpot body 100 may be any one of a variety of known flowerpot shapes.

The flowerpot body 100 is capable of storing water and is open at an upper end.

At least one or more accommodating parts 114 and 116 are provided in the flowerpot body 100, and the flowerpot casing part 200 is fitted to the accommodating parts 114 and 116. The accommodating parts 114 and 116 may be provided in two, a left accommodating part 114 and a right accommodating part 116 as shown in FIG. 1, but is not limited thereto.

In the flowerpot body 100, a left-side frame part 104 and a right-side frame part 106 are connected forward F to both left and right ends of a rear part 102, respectively, and the left accommodating part 114 is connected to front end of the left-side frame part 104 in a form protruding forward F, and the right accommodating part 116 is connected to front end of the right-side frame part 106 in a form protruding forward F. The left-side frame part 104 and the right-side frame part 106 each serve as a side wall, and a support part (not denoted by a reference numeral), which serves as a leg, is formed on the lower surface. The support part also serves as a coupling part when stacking vertically.

In addition, a central end 114a of the left accommodating part 114 and a central end 116a of the right accommodating part 116 are connected at the center of the flowerpot a central frame part 108. The central frame part 108 serves as a connecting part connecting the left accommodating part 114 and the right accommodating part 116, and a support part (not denoted by a reference numeral), which serves as a leg, is formed on the lower surface.

In addition, the flowerpot body 100 is formed with a bottom part 110, connecting lower sides of the rear part 102, the left-side frame part 104, the right-side frame part 106, the left-side accommodating part 114 and the right-side accommodating part 116. The bottom part 110 provides a function of storing water.

In addition, a drain tube 120 is further formed above the bottom part 110 in the flowerpot body 100 to have a predetermined height. A drain through-hole (not denoted by a reference numeral) may be formed in the drain tube 120.

The flowerpot casing part 200 is fitted to the left accommodating part 114 and the right accommodating part 116, respectively, and a water supply hole 200a for water supply is formed at the bottom. Flowers or plants planted inside the flowerpot casing part 200 may absorb water stored at the bottom of the flowerpot body 100 through the water supply hole 200a.

In the present embodiment, the plurality of flowerpots 10 are disposed at adjacent positions in the vertical or horizontal direction and are connected to each other through the water supply tube 20 to supply water. For convenience of description, an example arranged in the left and right directions is illustrated in the drawing.

At least one through-hole 104a or 106a may be formed on one side of the flowerpot body 100. Here, the through-hole 104a or 106a may be formed on a side surface of the flowerpot body 100, but is not limited thereto.

As an embodiment, a first through-hole 104a is formed in the left-side frame part 104 in the transverse direction, and a second through-hole 106a is formed in the right-side frame part 106 in the transverse direction.

Through the above configuration, in a state where another flowerpot 10 is located adjacent to the left or right side of one flowerpot 10, the flowerpot of the embodiment may supply water stored in one flowerpot 10 to another flowerpot 10 in a transverse direction through the water supply tube 20 that interconnects the first through-hole 104a of one flowerpot 10 and the second through-hole 106a of another flowerpot 10.

In the embodiment, one flowerpot 10 is not necessarily connected to only one other flowerpot 10, and the water supply tube connection structure of the embodiment may be applied to various sides connected to two or more pots 10 arranged at the front, rear, up, down, or left and right simultaneously.

The water supply tube 20 configured as a hollow silicone rubber hose, having an outer diameter d22 larger than an inner diameter d11 of each of the through-holes 104a and 106a, can be inserted into the through-holes 104a and 106a in a state in which the outer diameter d22 is elastically reduced by an external force (for example, the force exerted by the operator's hand or instrument) wherein the outer diameter d22 is configured to achieve close contact state with an inner diameter surface d11-1 of each of the through-holes 104a and 106a when the outer diameter d22 is elastically restored by removing the external force while being inserted into each of the through-holes 104a and 106a. This state can be understood through FIG. 3.

In general, since the flowerpot 10 does not contain a large amount of water, a water pressure is not high. Therefore, just excellent elastic restoring force of the silicone rubber hose is sufficient to achieve close contact with the through-holes 104a and 106a of the flowerpot 10, and water leakage can be prevented. In particular, when a silicone rubber hose having a large thickness (the thickness between the outer diameter and the inner diameter) of the tube is used, better resilience and close contact can be obtained.

As an embodiment, when the inner diameter d11 of the through-holes 104a and 106a is 9.5 mm, the outer diameter d22 of the water supply tube 20 may be 10 mm, and the inner diameter d21 may be 6 mm.

A known silicone rubber hose, commercially available for medical equipment or food machinery, may be used as the silicone rubber hose of the present embodiment.

In terms of compression set, the compression set of ordinary organic rubber increases significantly with temperature changes, while silicone rubber maintains elasticity and resilience in a wide temperature range from −100 to 250° C., so it can exhibit excellent performance even when compression deformation is required under extreme conditions.

In terms of compressive resistance, silicone rubber has a restoring property that returns to the original shape when pressed between temperatures of −85 to 260° C.

In terms of weather resistance, unlike other organic rubber, silicone rubber has no double bond that reacts with oxygen, ozone, and ultraviolet rays in the atmosphere in the molecular structure to generate cracks, and due to its superior weather resistance, there is little change in physical properties even though the silicone rubber is left outdoors for a long time.

Based on the excellent elasticity, restoration properties, and weather resistance of silicone rubber, the inventor confirmed that when the silicone rubber hose is used as the water supply tube 20, it can maintain close contact state that does not leak water with unaffected state by external climate (e.g. temperature change, oxidation, ozone, ultraviolet light, etc.), even when inserted into the through-holes 104a and 106a without using an additional packing member. These silicone rubber hoses characteristics cannot be obtained from other organic rubber.

Preferably, the flowerpot body 100 is made of a harder material (e.g., hard synthetic resin) than a silicone rubber hose. Through this, when the water supply tube 20 which is inserted into the through-holes 104a and 106a, in a state in which the outer diameter d22 is elastically reduced by the external force, is elastically restored by removing the external force, the outer surface of the water supply tube 20 and the through-holes 104a and 106a of the flowerpot body 100 form a strong contact state, effectively preventing water leakage and separation of the water supply tube 20 from the through-holes 104a and 106a by the external force.

The through-holes 104a and 106a of the side surface to which the water supply tube 20 is not inserted may be blocked by respective stoppers 190.

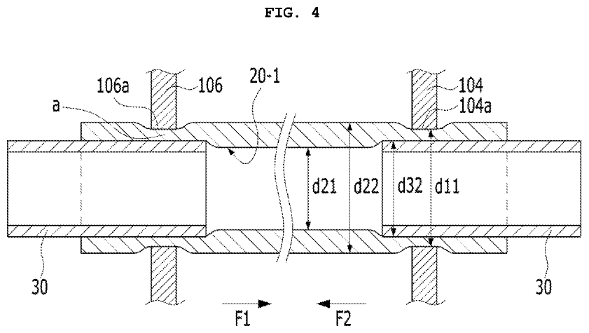

FIG. 4 is a partially extracted cross-sectional view illustrating the connection structure of the flowerpot including the water supply tube 20 according to a further embodiment of the present disclosure.

In the embodiment, the coupling between the water supply tube 20 and the flowerpot body 100 is further strengthened by using a connecting tube 30 formed of a harder material than the water supply tube made of a silicone rubber material.

The connecting tube 30 is made of a harder material than the silicone rubber hose and configured to be inserted into a hollow part 20-1 of the water supply tube 20 that is in a state of being inserted into the through-holes 104a and 106a of the flowerpot body 100.

As an embodiment, the connecting tube 30 of the embodiment is preferably have an outer diameter d32 larger than the inner diameter d21 of the water supply tube 20 so as to be inserted into the hollow inner surface 20-1 of the water supply tube 20 and closely contacted thereto, but is not limited thereto. For example, as shown in FIG. 3, in a state in which the water supply tube 20, which is a silicone rubber hose, is inserted into the through-holes 104a and 106a of the flowerpot body 100, a protrusion 20-2 may be formed on the hollow inner surface 20-1 of the water supply tube 20 by elastic deformation, and if it can be closely contacted to the protrusion 20-2, the connecting tube 30 does not necessarily have an outer diameter d32 larger than the inner diameter d21 of the water supply tube 20.

The connecting tube 30 of the embodiment is inserted toward the through-holes 104a and 106a in the inner space of the flowerpot body 100, and is inserted into the hollow inner surface 20-1 through the end of the water supply tube 20 in a state of being inserted into the through-holes 104a and 106a.

Preferably, the connecting tube 30 is made of a urethane material or a metal material. However, if the material is harder than the silicone rubber hose and is easy to manufacture as a hollow tube, the connecting tube 30 is made of another material.

The outer diameter d32 of the connecting tube 30 is configured to be smaller than the inner diameter d11 of each of the through-holes 104a and 106a, and at least a portion of the connecting tube 30 is inserted into the inner surface 20-1 of the hollow part of the water supply tube 20 to achieve the close contact state while being inserted into the through-holes 104a and 106a of the flowerpot body 100. This state can be understood through FIG. 4.

As an embodiment, when the inner diameter d11 of each of the through-holes 104a and 106a is 9.5 mm, the outer diameter d22 of the water supply tube 20 may be 10 mm, the inner diameter d21 may be 6 mm, and the outer diameter d32 of the connecting tube 30 may be 7-8 mm.

When the connecting tube 30 passes through the through-holes 104a and 106a of the flowerpot body 100, the outer surface of the water supply tube 20 is more strongly contacted to the through-holes 104a and 106a, while the connecting tube 30 is located inside the water supply tube 20, and may effectively prevent water leakage (point a) and separation of the water supply tube 20 from the through-holes 104a and 106a by the external force F1 or F2.

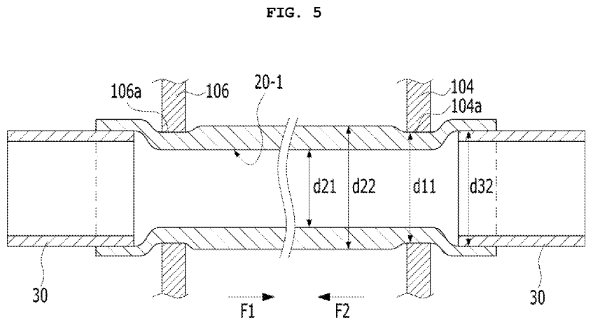

FIG. 5 is a partially extracted cross-sectional view illustrating the connection structure of the flowerpot including the water supply tube according to a further embodiment of the present disclosure.

In the present disclosure, the outer diameter d32 of the connecting tube 30 is configured to be not smaller than the inner diameter d11 of each of the through-holes 104a and 106a, and the connecting tube 30 is inserted into the inner surface 20-1 of the hollow part of the water supply tube 20 to achieve the close contact state while not inserted to the through-holes 104a and 106a of the flowerpot body 100. This state can be understood through FIG. 5.

As an embodiment, when the inner diameter d11 of each of the through-holes 104a and 106a is 9.5 mm, the outer diameter d22 of the water supply tube 20 may be 10 mm, the inner diameter d21 may be 6 mm, and the outer diameter d32 of the connecting tube 30 may be 9.5-11 mm.

When the connecting tube 30 is configured to have a larger outer diameter than the embodiment of FIG. 4 and forms close contact state that does not pass through the through-holes 104a and 106a of the flowerpot body 100, in a state in which the connecting tube 30 elastically expands and deforms the end of the water supply tube 20, the connecting tube 30 is caught in the through-holes 104a and 106a so as not to be separated from the inner space of the flowerpot body 100 to the outside, effectively preventing the separation of the water supply tube 20 from the through-holes 104a and 106a by the external force thereby.

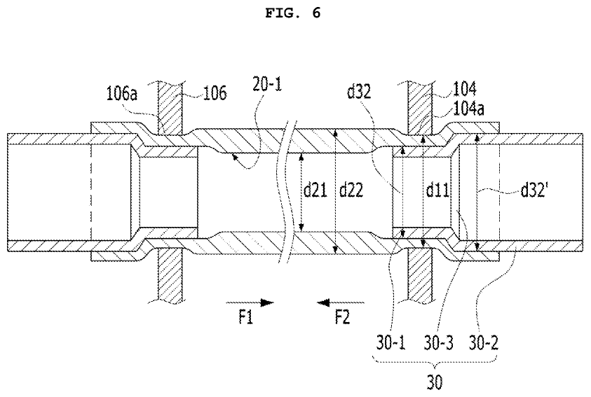

FIG. 6 is a partially extracted cross-sectional view illustrating the connection structure of the flowerpot including the water supply tube according to a still yet further embodiment of the present disclosure.

In the present embodiment, the connecting tube 30 is configured in a form in which a first section 30-1 thereof having an outer diameter d32 smaller than the inner diameter d11 of each of the through-holes 104a and 106a and a second section 30-2 thereof having the outer diameter d32′ not smaller than the inner diameter d11 of each of the through-holes 104a and 106a are integrally connected to each other along a longitudinal direction. Reference numeral 30-3 denotes a connection part between the first section 30-1 and the second section 30-2, and preferably have an inclined cross section.

As an embodiment, when the inner diameter d11 of each of the through-holes 104a and 106a is 9.5 mm, the outer diameter d22 of the water supply tube 20 may be 10 mm, the inner diameter d21 may be 6 mm, and the outer diameter d32 of the first connecting tube 30-1 may be 7-8 mm, wherein the outer diameter d32′ of the second connecting tube 30-2 may be 9.5-11 mm

In the first section 30-1, a part of connecting tube 30 is inserted into the inner surface 20-1 of the hollow part of the water supply tube 20 to form close contact state while being inserted into the through-holes 104a and 106a of the flowerpot body 100.

In the second section 30-2, the connecting tube 30 is inserted into the inner surface 20-1 of the hollow part of the water supply tube 20 to achieve the close contact state while not inserted to the through-holes 104a and 106a of the flowerpot body 100

This state can be understood through FIG. 6.

According to the configuration of the present embodiment, the advantages of the above-described embodiment of FIG. 4 and the advantages of the embodiment of FIG. 5 can be obtained together.

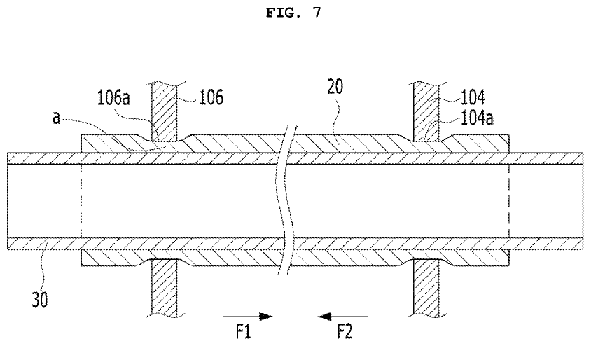

FIG. 7 is a partially extracted cross-sectional view illustrating the connection structure of the flowerpot including the water supply tube according to a still yet further embodiment of the present disclosure.

In the present embodiment, as shown in FIG. 2, one flowerpot 10 and another flowerpot 10 are adjacently arranged side by side, and one water supply tube 20 is inserted into the through-holes 104a and 106a of each flowerpot 10.

The outer diameter of the connecting tube 30 is smaller than the inner diameter of each of the through-holes 104a and 106a.

In the state in which one connecting tube 30 is inserted into the inner surface 20-1 of the hollow part of the water supply tube 20, the connecting tube 30 is configured to pass through the through-hole 106a of one pot body 100 (left-side pot body) and pass through the through-hole 104a of another pot body 100 (right-side pot body) to achieve the close contact state.

In the case of taking such a configuration, it is possible to provide the advantages of FIG. 4 described above while going through a simpler assembly process using one connecting tube 30. In particular, the present embodiment is advantageous when both flower pots 10 are disposed adjacent to each other.

On the other hand, one flowerpot 10 is not necessarily connected to only one other flowerpot 10, and the water supply tube connection structure of the embodiment may be applied to various sides connected to two or more pots 10 arranged at the front, rear, up, down or left and right simultaneously.

Although the present disclosure has been described with reference to the accompanying drawings, it will be apparent to those skilled in the art that many various and obvious modifications are possible without departing from the scope of the invention from this description. Therefore, the scope of the invention should be construed by the claims described to include examples of such variations.

1. A flowerpot equipped with a water supply tube, the flowerpot comprising:
a flowerpot body capable of storing water therein, being open at an upper end thereof, and having at least one through-hole at one side thereof; and
a water supply tube configured as a hollow silicone rubber hose having an outer diameter larger than an inner diameter of the through-hole, and configured to be inserted into the through-hole in a state in which the outer diameter thereof is elastically reduced by an external force and is configured to achieve a close contact state with an inner surface of the through-hole when the outer diameter of the water supply tube is elastically restored by removing the external force while being inserted into the through-hole, wherein a plurality of flowerpots are arranged to be adjacent to each other and interconnected with the water supply tube.

2. The flowerpot of claim 1, further comprising:
a connecting tube made of a harder material than the silicone rubber hose and configured to be inserted into a hollow part of the water supply tube when being inserted into the through-hole of the flowerpot body.

3. The flowerpot of claim 2, wherein an outer diameter of the connecting tube is configured to be smaller than the inner diameter of the through-hole, and at least a portion of the connecting tube is inserted into the hollow part of the water supply tube to achieve the close contact state while being inserted into the through-hole of the flowerpot body.

4. The flowerpot of claim 2, wherein an outer diameter of the connecting tube is configured to be not smaller than the inner diameter of the through-hole, and the connecting tube is inserted into the hollow part of the water supply tube to achieve the close contact state while not inserted into the through-hole of the flowerpot body.

5. The flowerpot of claim 2, wherein the connecting tube is configured in a form in which a first section thereof having an outer diameter smaller than the inner diameter of the through-hole and a second section thereof having an outer diameter not smaller than the inner diameter of the through-hole are integrally connected to each other along a longitudinal direction, wherein in the first section, a part of the connecting tube is inserted into the hollow part of the water supply tube to form the close contact state while being inserted into the through-hole of the flowerpot body, and in the second section, the connecting tube is inserted into the hollow part of the water supply tube to form the close contact state while not inserted to the through-hole of the flowerpot body.

6. The flowerpot of claim 2, wherein one flowerpot and another flowerpot are adjacently arranged side by side, and one water supply tube is inserted into the through-hole of each flowerpot, and an outer diameter of the connecting tube is smaller than the inner diameter of the through-hole, and the connecting tube is configured such that in a state in which one connecting tube is inserted into the hollow part of the water supply tube, the connecting tube passes through the through-hole of one flowerpot body and passes through the through-hole of the other flowerpot body to achieve the close contact state.

7. The flowerpot of claim 2, wherein the connecting tube is made of a urethane material or a metal material.

8. The flowerpot of claim 2, wherein the connecting tube has an outer diameter larger than the inner diameter of the water supply tube.

9. The flowerpot of claim 1, wherein the water supply tube is configured to prevent a leakage of water by being brought into close contact with the inner surface of the through-hole due to an elastic restoring force of the silicone rubber hose.

10. The flowerpot of claim 1, wherein the flowerpot body is formed of a harder material than the silicone rubber hose.
